(19) United States
(12) Patent Application Publication
(10) Pub. No.: US 2024/0036519 A1
(43) Pub. Date: Feb. 1, 2024

(54) TIMEPIECE DIAL

(71) Applicant: ROLEX SA, Geneva (CH)

(72) Inventors: Alain Pavinato, Thonon-les-Bains (FR); Alain Thabuis, Geneva (CH)

(73) Assignee: ROLEX SA, Geneva (CH)

(21) Appl. No.: 18/359,441

(22) Filed: Jul. 26, 2023

(30) Foreign Application Priority Data
Jul. 28, 2022 (EP) 22187649.3

(51) Int. Cl. G04B 19/14

(52) U.S. Cl. CPC G04B 19/14

(57) ABSTRACT

Dial (20) for a timepiece (300)
including a dial plate (21), at least one dial foot (22) extending along a foot axis (A1) and having a shaping (231), notably a notch (23), oriented toward the dial plate and intended to receive a mechanical action that presses the plate against a clockwork movement (10), particularly against a frame (11) of a clockwork movement (10),
and a first zone (40) of lower rigidity configured or arranged to deform elastically and/or plastically, in a direction mainly parallel to the axis (A1) of the foot, as the mechanical action is applied to the shaping (231), a portion of the first zone being provided with a lower material profile so as to constitute a portion of the dial that is able to be mainly deformed or experience most of the deformation, and a flexible blade of the first zone extending substantially perpendicular to the axis (A1) of the foot and set into the rest of the foot at one of its ends.

This application claims priority of European patent application No. EP22187649.3 filed Jul. 28, 2022, the content of which is hereby incorporated by reference herein in its entirety.

The invention relates to a timepiece dial. The invention also relates to a fixing element for fixing a dial to a clockwork movement of a timepiece. The invention also relates to an assembly comprising such a dial and/or such a fixing element. The invention finally relates to a timepiece comprising such an assembly and/or such a dial and/or such a fixing element.

### BACKGROUND ART

Dial feet are commonly attached to a dial plate by welding or brazing. The positioning of these feet on the dial plate is relatively imprecise. As a result, they are generally dimensioned in such a way that a watchmaker can deform them slightly in order to correct the positioning of the dial when assembling it on a movement.

It is known practice to centre a dial on a movement via the periphery of the dial using a skirt. The skirt may be arranged on the movement or on the dial. Although this solution offers particularly precise centring, it necessarily constrains the size of the dial with respect to that of the movement because these two components need to be of comparable size in order to benefit from this type of centring.

The work entitled “Théorie d′horlogerie [Theory of Horology]” (Reymondin et al., published by the Federation des Ecoles Techniques, 1998) discloses a solution known to those skilled in the art which consists in clamping a dial foot laterally within a housing simply using the screw arranged perpendicular to the latter. The pressure of the screw against the foot is able to cause radial deformation of the foot.

Documents CH1775367A4 and CH610705B disclose two other solutions known to those skilled in the art. Those documents relate to fixing devices provided with latches which respectively take the form of a key and of an eccentric. These latches are provided with a knife-shaped portion intended to penetrate the dial foot forming a notch therein when the device is in the fixed configuration. The notch inevitably leads to radial deformation of the foot.

Nowadays, the fixing devices generally employed have a tendency to deform the dial feet radially or laterally, particularly by shearing or work-hardening same. The aforementioned radial deformations imply permanent deformations that are liable to complicate subsequent operations of removing the dial and refitting it on the movement. Specifically, these deformations mean that mechanical effort has to be applied in order to assemble/disassemble the dial relative to the clockwork movement. Moreover, because of the delicate nature of the decoration on a dial and the fragility thereof, it is of utmost importance to avoid any appreciable force to the dial when assembling or disassembling as such forces are liable to deform or damage the dial.

### SUMMARY OF THE INVENTION

It is an object of the invention to provide a timepiece dial that makes it possible to improve the dials known from the prior art. In particular, the invention proposes a dial that can be fitted on and removed from a clockwork movement without force or with the application of very negligible amounts of force.

According to the invention, a timepiece dial is defined by point 1 below.
1. Dial for a timepiece comprising:
   a dial plate, and
   at least one dial foot extending along a foot axis, the foot axis being, for example, perpendicular or substantially perpendicular to the dial plate, the at least one foot comprising
a shaping, notably a shaping as a notch, the shaping being oriented
   toward the dial plate and intended to receive a mechanical action that presses the plate against a clockwork movement, particularly against a frame of a clockwork movement, and
   a first zone of lower rigidity configured or arranged in such a way as to deform elastically and/or plastically, in a direction mainly parallel to the axis of the foot, as the mechanical action is applied to the shaping, wherein the first zone of lower rigidity is arranged and/or configured in such a way as to have a portion provided with a lower material profile so as to constitute a portion of the dial that is able to be mainly deformed or experience most of the deformation as the mechanical action is applied to the shaping, and
wherein the first zone of lesser rigidity forms a flexible blade extending substantially perpendicular to the axis of the foot and set into the rest of the foot at one of its ends.

Embodiments of the dial are defined by points 2 to 7 below.
2. Dial according to point 1, characterized in that the first zone of lower rigidity is positioned at a distal end of the foot and has a thickness between:
   the shaping, and
   the distal end of the foot,
this first thickness being at least a factor of two or at least a factor of three times smaller than a thickness of the smallest of the cross sections of the foot found between the shaping and the plate.
3. Dial according to one of the preceding points, characterized in that the plate and the at least one foot are monobloc or formed as a single piece.
4. Dial according to one of the preceding points, characterized in that the foot comprises positioning surfaces, the surfaces being intended for positioning the dial with the smallest amount of play relative to a mount and/or relative to a clockwork movement, particularly relative to a frame of a clockwork movement.
5. Dial according to the preceding point, characterized in that one or some of the positioning surfaces or all of the positioning surfaces are located at a proximal end of the foot.
6. Dial according to point 4 or 5, characterized in that the foot comprises a base on which the positioning surface is formed, the base having cross sections transverse to the foot, of which the cross sectional areas are greater than the cross sectional areas of the other zones of the foot.
7. Dial according to one of the preceding points, characterized in that the dial comprises several feet, notably two feet or three feet, and in that the dial feet are positioned relative to one another and/or relative to the dial plate with a positioning tolerance of less than 60 μm, or even of less than 40 μm, and preferably of 20 μm or less.

According to the invention, a fixing element is defined by point 8 below.
8. Fixing element, particularly screw or latch or key or eccentric, intended to be mounted on a clockwork movement, particularly on a frame of a clockwork movement, characterized in that the fixing element comprises a pressing zone intended to press against a shaping of a dial foot and in that the fixing element comprises a second zone of lower rigidity configured or designed to deform elastically and/or plastically when a mechanical action is being applied by the pressing zone to the shaping of a dial foot.

One embodiment of the fixing element is defined by point 9 below.
9. Fixing element according to point 8, characterized in that the second zone of lower rigidity is arranged and/or configured to exhibit a portion in the form of a flexible blade intended to be connected to a frame at one of its ends, the flexible blade being:
   intended to extend substantially perpendicular to an axis of a foot, and
   capable of being mainly deformed, notably in bending, as the mechanical action is applied to the shaping.

According to the invention, an assembly is defined by point 10 below.
10. Assembly comprising
   a clockwork movement comprising at least one housing to receive a foot or a mount comprising at least one housing to receive a foot, and
   a dial according to one of points 1 to 7 and/or at least one fixing element according to one of points 8 and 9.

Embodiments of the assembly are defined by points 11 and 12 below.
11. Assembly according to the preceding point, characterized in that the radial clearance between:
   at least one of the positioning surfaces, and
   one of the housings is less than 40 μm, or even less than 25 μm and preferably greater than or equal to 10 μm,
and/or in that
the ratio:
   of the diameter of the smallest circle circumscribing the surface to
   said radial clearance between said surface and said housing, is preferably greater than 25, or even greater than 50, or even still greater than 100.
12. Assembly according to point 10 or 11, characterized in that at least one of the housings has an oblong cross section oriented in the direction of another of the housings.

According to the invention, a timepiece is defined by point 13 below.
13. Timepiece, notably wristwatch, comprising:
   a dial according to one of points 1 to 7, and/or
   at least one fixing element according to one of points 8 to 9, and/or
   an assembly according to one of points 10 to 12.

### BRIEF DESCRIPTION OF THE DRAWINGS

The attached drawings depict, by way of example, two embodiments of a timepiece according to the invention.

FIG. 1 is a schematic view of a first embodiment of a timepiece according to the invention.

FIG. 2 is a view in partial section of a first embodiment of an assembly according to the invention, in a configuration of retaining a dial on a movement.

FIG. 3 is a view in partial section of the first embodiment of the assembly according to the invention in a configuration of releasing the dial from the movement.

FIG. 4 is a view in partial section of an assembly formed by a dial and a mount.

FIG. 5 is an exploded view of a variant of the embodiment of an assembly as depicted in FIGS. 2 and 3.

FIG. 6 is a view in partial section of one embodiment of a dial.

FIG. 7 is a view in partial section of a second embodiment of an assembly according to the invention in a configuration of retaining a dial on a movement.

### DETAILED DESCRIPTION OF PARTICULAR EMBODIMENTS

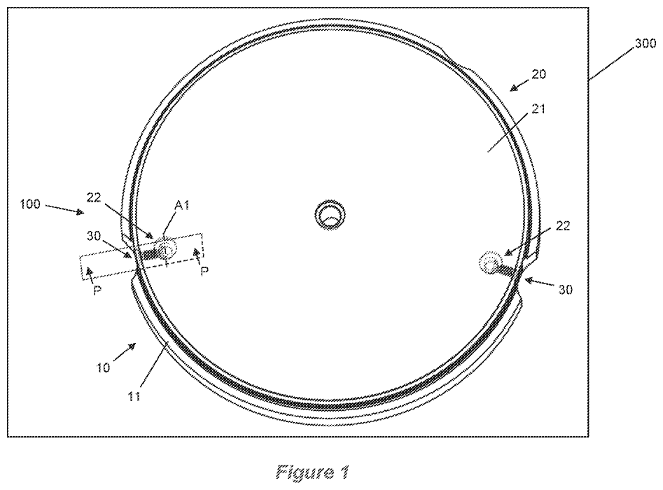

A first embodiment of a timepiece 300 is described hereinafter in detail with reference to FIGS. 1 to 6.

The timepiece 300 is, for example, a watch, particular a wristwatch. The timepiece 300 comprises an assembly 100 including:
a clockwork movement 10,
a dial 20, and
at least one fixing element 30, preferably two or three fixing elements 30.

The fixing element 30 is intended for fixing the dial 20 on the clockwork movement 10.

The assembly 100 is intended to be mounted in a timepiece case in order to protect it from the external environment.

The clockwork movement 10 may be a mechanical movement, notably an automatic movement, or else a hybrid movement. Alternatively, the movement may be an electronic movement.

The dial 20 comprises:
a dial plate 21, and
at least one dial foot 22 extending along a foot axis A1, the at least one foot comprising:
a shaping 231 notably a shaping 231 as a notch 23, the shaping 231 being oriented toward the dial plate and intended to receive a mechanical action that presses the plate against a clockwork movement 10, particularly against a frame 11 of the clockwork movement 10, and
a first zone 40 of lower rigidity configured or arranged in such a way as to deform elastically and/or plastically, in a direction mainly parallel to the axis A1 of the foot, as the mechanical action is applied to the shaping 231.

The shaping 231 comprises a face or a surface that is intended to receive, in contact with it, a mechanical action for holding the dial on the movement 10. The shaping 231 is oriented toward the dial plate, in the sense that the face or surface intended to receive the mechanical action has, at the point of application of the action, an orientation (that of its normal vector N emerging from the material of the shaping at the point of application of the action) that is directed toward the plate. As a preference, this orientation is, as far as possible, parallel to the axis A1.

As a preference, the axis or axes A1 of the feet are perpendicular or substantially perpendicular to the dial plate. As a further preference, the axis or axes A1 pass substantially through the centre of the cross section or cross sections of the foot or of the feet.

The plate 21 is intended to press against the frame 11 of the clockwork movement 10. The dial 20 is held on the frame 11 by one or more fixing devices including the fixing elements 30. The plate 21 preferably comprises a face visible to the wearer of the watch. This face may be decorated. The plate 21 also preferably comprises one or more indexes and/or one or more windows which collaborate with indicators, such as hands and/or discs, to indicate time information or information derived from the time.

The dial 20 preferably comprises two feet 22 as in the first embodiment depicted, or three feet. The at least one foot 22 is intended to sit into a housing 12 produced, particularly machined, in the frame 11.

At least one device for fixing the dial to the frame, or else each fixing device, comprises a foot 22 and a fixing element 30. For the sake of simplicity, just one fixing device is described in detail. However, the assembly 100 or the timepiece 300 preferably comprises as many fixing devices as there are dial feet 22.

The foot or feet 22 are advantageously formed as one with the plate 21. In particular, the foot or feet 22 may be machined as one with the dial plate 21 from solid. The machining technology adopted to obtain the dial may therefore be dependent on the material used to make the dial 20. The dial 20 including:
the plate, and
the foot or feet,
is thus preferably monobloc.

As an alternative, the foot or feet 22 may be obtained,
by attaching foot blanks to a plate blank, notably attaching them using welding or brazing, and then
by machining the whole, or at least the foot or the feet, so that the feet are wholly or mainly formed of the material of the foot blanks and so that the plate is fully or mainly formed by the material of the plate blank.

Alternatively, the foot or feet 22 may be formed as one with the plate 21 by electroforming or by any casting technique. If need be, the feet may be finished using machining.

Thus, the foot or feet and the plate may be made (mainly) of different materials.

The dial is advantageously made from a copper-based material such as brass. As an alternative, it may be made from another, preferably ductile, material such as gold or platinum. As a preference, the screw or the fixing element 30 is advantageously machined from a harder material than the dial, for example a steel, so that the zone of lower rigidity 40 is the zone that is predominantly or mainly deformed.

In general, the plate may notably be made from one of the following materials:
a copper-based material such as a brass,
a precious metal such as gold or platinum.

In general, the foot or feet may notably be made from one of the following materials:
a copper-based material such as a brass,
a precious metal such as gold or platinum.

Obtaining the foot or feet using the abovementioned techniques allows the foot or the feet 22 to be positioned very precisely on the plate 21. In particular, this foot or these feet may be positioned far more precisely on the plate (and relative to one another) than if they were attached, for example by welding or brazing, without subsequent machining rework. In other words, these characteristics make it possible to enjoy a high degree of precision in the positioning of the foot or of the feet 22 on the plate 21. For example, the dial feet are positioned relative to one another with a position tolerance of less than 60 μm or even less than 40 μm and preferably of 20 μm or less. As a further example, each dial foot is positioned relative to the plate with a positioning tolerance of less than 60 μm, or even less than 40 μm and preferably of 20 μm or less. These positioning tolerances are therefore comparable with the tolerances on the positioning of one blank relative to the other within a clockwork movement. The precision with which the feet are positioned makes it possible to benefit from a radial clearance j1 between the foot 22 and the housing 12 that is less than 40 μm or even less than 25 μm and preferably greater than or equal to 10 μm.

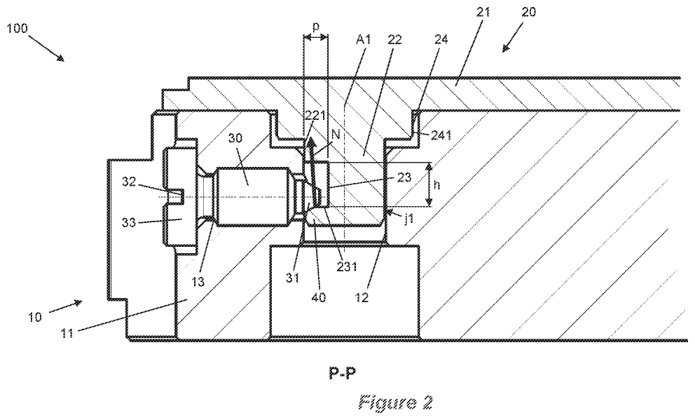

FIG. 2 illustrates a cross section along a plane P passing through the axis A1 of a dial foot 22 and the centre of the frame 11. The fixing device here is in a locking first configuration E1, which is to say that the fixing element 30 is collaborating with the foot 22, notably acting as an obstacle, in order to retain and/or press the dial 20 on/onto the frame 11.

The housing 12 is advantageously machined in the frame in such a way as to encompass the foot 22 with a minimum of clearance j1 so as to ensure high precision assembly of the dial in the frame. The close fit between the foot 22 and the housing 12 is such that any correction of the positioning of the dial relative to the movement becomes superfluous. Further, the clearance J1 between the foot 22 and the housing 12 of the frame 11 is large enough to allow the dial to be assembled or disassembled without the need to apply force to the dial, or by applying only a very negligible force.

The fixing element 30 is liable to collaborate with the shaping 231 produced, notably by machining, on the foot 22. The fixing element 30 may be positioned in at least two distinct configurations.

In a locked first position P1, the fixing element 30 is engaged in contact with the shaping 231, notably in the slot or the notch 23 of the foot, so as to secure the dial to the frame 11, configuring the fixing device in the locking first configuration E1 depicted in FIG. 2.

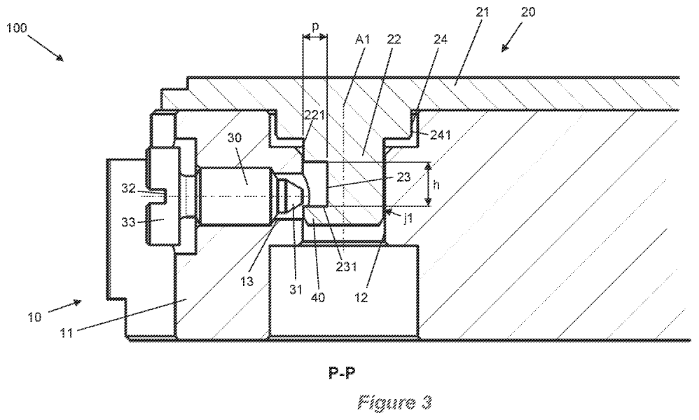

In an unlocked second position P2, the fixing element 30 is disengaged from the shaping 231, notably from the notch 23 of the foot, so as to allow the dial to be disassembled without the application of force, or with the application of only a very negligible force, configuring the fixing device in an unlocked second configuration E2 depicted in FIG. 3.

More specifically, the shaping 231 is capable of collaborating with a first portion 31 comprised in the fixing element 30. It is this first portion 31 that is engaged against the shaping 231 in the locked first configuration E1, and disengaged from the shaping 231 in the unlocked second configuration E2. Advantageously, when the fixing element 30 is moved from the second to the first position, this first portion 31 and/or the shaping 231 have a geometry that allows an axial force to be applied progressively to the foot, along the axis A1, as the movement progresses. In other words, thanks to this or these geometries, the axial force on the foot increases progressively with the movement of the fixing element 30 toward the locked first position P1. The collaboration between the shaping 231 and the first portion 31 can be likened to a linkage of the cam-31—follower 231 type.

This or these geometries advantageously allow collaboration between the first portion 31 and the shaping 231 that avoids undesirable deformation of the foot, such as:
shearing of at least part of the foot,
crushing or work-hardening of at least part of the foot, or else
transverse bending of the foot relative to the axis A1.

To achieve that, said geometry or geometries have a cross section provided with a straight or curved segment which is inclined, notably inclined at a right angle, with reference to the direction of axial deformation, more particularly with reference to the axis A1. This or these geometries allow the movement of the first portion 31 of the fixing element 30 to be converted into an axial movement of the foot 22 along the axis A1 and/or into an axial force on the foot 22 along the axis A1, more particularly into an axial movement of the shaping 231 along the axis A1 and/or into an axial force on the shaping 231 along the axis A1.

The fixing element 30 comprises a second portion 32 that allows a watchmaker to actuate the fixing element 30 in such a way as to position it in the at least one first or second position P1, P2, and in particular that allows the transition from one of the first and second positions to the other. The second portion 32 is intended to collaborate with a watchmaking tool, such as a screwdriver, or tweezers, or a wooden or plastic dowel. The fixing element 30 may comprise a screw thread collaborating with a tapped thread produced in the frame 11.

The fixing element 30 may also comprise a stop 33 liable to come to bear against the frame 11. This stop 33 limits the travel of the fixing element 30 when the device is in the locked first configuration E1 so as to prevent the fixing element 30 from being moved too far and therefore causing lateral or radial deformation of the foot 22 relative to the axis A1.

As was seen earlier, one foot, some feet or all of the feet advantageously comprise a zone 40 of lower rigidity or of preferred deformation. This zone of lower rigidity is intended to deform axially, which is to say preferably along the axis A1, when the fixing element 30 is in the locked first configuration E1.

In the unlocked second configuration E2, this zone 40 is not stressed. It may revert to an initial or rest configuration under the effect of the elasticity of the material of which it is made.

Advantageously, the geometry of the zone 40 is intended to favour axial deformation of the foot and not give rise to lateral or radial deformation of the foot 22 as this could cause:
the guidance of the foot or of the feet in the frame 11,
the precision of the positioning of the foot or of the feet in the frame 11,
the disassembly and/or the assembly of the dial within the movement to be bypassed.

In other words, in the locked first configuration E1, the deformation of the zone 40 comprises a component of deformation that is mainly axial, along the axis A1, which is substantially greater than the components in the other directions of deformation (perpendicular to the axis A1).

The component of deformation that is mainly axial, along the axis A1, may be the result of a bending and/or of a work-hardening of the zone 40.

The small radial clearance j1 requires that the permissible lateral or radial deformation of the foot needs to be minimal and less than this clearance j1, hence the importance of making use of a zone 40 of lower rigidity intended to deform mainly axially along the axis A1.

The zone 40 is deformed in such a way as to apply a mainly axial force to the foot 22, which force is oriented in such a way as to ensure optimum pressing of the dial 20 against the clockwork movement 10.

The deformation of the zone 40 may be plastic and/or elastic. As a preference, the deformation is at least partially elastic so as to ensure optimum pressing of the dial.

Therefore the zone 40 is designed in such a way as to have a lower axial rigidity than the rest of the dial so that the plate 21 and the rest of the foot 22 can notably be considered to be infinitely rigid relative to the zone 40.

By virtue of its deformation, the zone 40 of lower rigidity advantageously also makes it possible to limit the axial force applied to the dial in the first configuration E1 and therefore it avoids giving rise to deficiencies in the flatness of the plate 21 which could detract from the aesthetics of the dial and particularly the decoration thereof.

In order to make the foot 22 more rigid and encourage axial deformation of the zone 40, the foot may advantageously comprise a base 24 in the region where it meets the dial plate 21. The junction with the plate occurs at the proximal end of the foot. This base 24 has a cross section of which the cross-sectional area is greater than the cross-sectional areas of the other zones of the foot 22, so as to make it more rigid.

Advantageously, the zone 40 of lower rigidity is produced at the distal end of the foot.

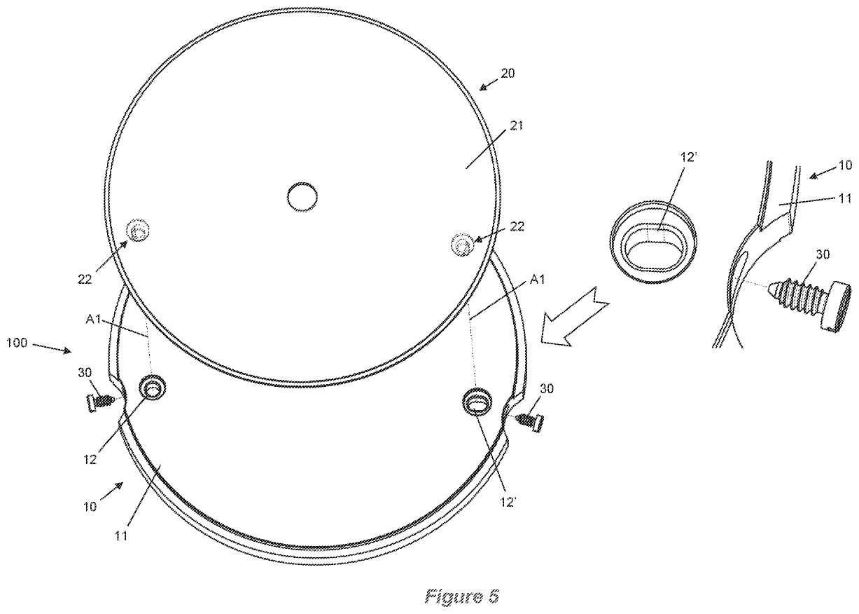

As a preference, thanks to the precise creation of the surfaces of the dial feet and of the housings that accommodate these feet, it is possible to position the dial 20 on the frame 11 in an isostatic manner (and not in hyperstatic manner). Specifically, the housings intended to respectively accommodate each of the feet 22 may have distinct geometries or formats. For example, a first housing 12 may be circular or substantially triangular, while a second housing 12′ may have an oblong geometry, notably an oblong geometry oriented at least substantially in the direction of the first housing 12. In other words, the first housing 12 may allow centring, and the second housing 12′ may allow orientation or alignment of the dial 20 on the frame 11. Such an oblong shaping of a housing is depicted in FIG. 5.

For the same purpose, statically determinate assembly involving feet 22 having distinct geometries or formats is also permitted.

In the embodiment described, the frame 11 is a blank or, more particularly, a movement plate 11 of the clockwork movement 10.

The foot 22 has an overall cylindrical geometry intended to collaborate with the housing 12 which may take the form of a cylindrical hole machined in the movement plate 11.

As described previously, a second housing 12′ may take another shape, notably the shape of an oblong hole collaborating with a second foot 22 so as to allow a statically determinate assembly of the dial.

As a preference, the base 24 likewise has a cylindrical or overall cylindrical geometry. As a further preference, the base 24 is coaxial with the axis A1. The length of the base 24 is advantageously chosen to ensure that the foot has optimal lateral or radial rigidity.

The fixing element 30 may be a screw 30 arranged, for preference, perpendicular to the foot 22 and substantially facing the shaping 231. More particularly, the screw 30 takes place in an at least partially tapped housing 13, perpendicular to the housing 12, machined in the movement plate 11.

The shaping 231 is advantageously bounded by one face of the notch 23. This notch is for example machined on a cylindrical part of the foot 22. It is produced for example by machining with a rectangular or substantially rectangular cross section, the side walls of which extend perpendicularly or substantially perpendicularly to the axis A1 of the foot 22 and/or the end wall of which extends parallel or substantially parallel to the axis A.

The second portion 32 advantageously has the form of a notably recessed socket, or slot 32 machined into the screw 30. This socket 32 is intended to collaborate with a watchmaking tool, notably a watchmaking screwdriver. It is via this socket that the watchmaker can act upon the fixing element 30 in order to position it in the at least first and second positions P1, P2 so as respectively to position the fixing element 30 in the locked and unlocked configurations E1, E2.

The stop 33 may be defined by a head 33 that the screw 30 comprises. In the locked first position P1, the screw head 33 is advantageously in abutment against the frame 11. This prevents the screw 30 from being screwed in too far and therefore deforming the foot 22 radially or laterally (relative to the axis A1) in the locked first configuration E1.

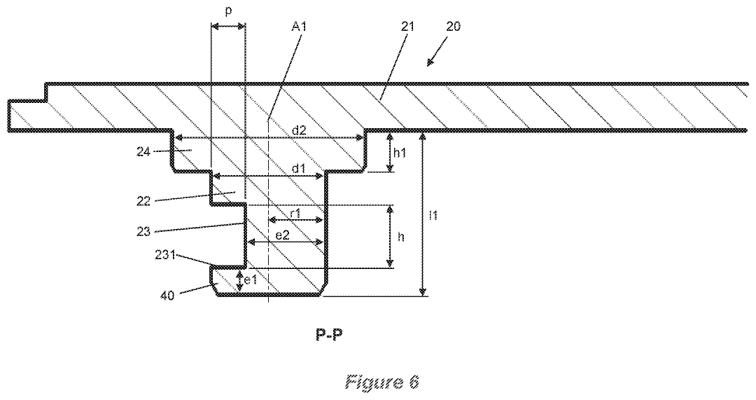

In the first embodiment depicted, the zone 40 of lower rigidity is situated at a distal end of the foot 22 (the opposite end from the end with the base 24 and where it meets the plate 21). More particularly, the foot at this distal end of the foot 22, has a thickness E1 (measured along the axis A1) of material remaining between the notch 23, particularly between the shaping 231, and said distal end of the foot 22, as depicted in FIG. 6. Said thickness E1 is notably dimensioned so that the zone 40 constitutes a zone of lower axial rigidity. In other words, the zone 40 consists of a tongue 40 that forms part of the foot 22 and extends perpendicularly or substantially perpendicularly to the axis A1 from the rest of the foot or the complementary (to the tongue) part of the foot. As a preference, this tongue has a thickness E1 that is constant over its entire extent. As an alternative, the thickness E1 of the tongue may vary in the plane along which the tongue extends. In particular, the thickness of the tongue may increase with increasing proximity to the complementary part of the foot. The shaping 231 mentioned hereinabove is thus, in this exemplary embodiment, a surface of the tongue 40. Thus, the first zone 40 of lower rigidity can be arranged and/or configured in such a way that it has a portion with a lower material profile so as to constitute a portion of the dial that is liable to be mainly deformed or to experience most of the deformation as the mechanical action is applied to the shaping 231. In addition, the first zone 40 of lower rigidity may form a tongue or a flexible blade extending perpendicularly to the axis A1 of the foot and set into the rest of the foot at one of its ends.

The first portion 31 is, in the embodiments of FIGS. 2 and 3, an end 31 of the screw 30 that has a conical or frustoconical geometry. It is this end 31 that is liable to collaborate with the zone 40 of lower rigidity, notably with the shaping 231 formed by the notch 23. Thus, when the fixing element 30 makes the transition from the unlocked second configuration E2 to the locked first configuration E1, the end 31 gradually engages in the notch 23, preferably giving rise to progressive deformation of the zone 40 as a result of the pressing of the frustoconical geometry against the shaping 231. This results in a mainly axial force on the foot 22.

There are a number of factors that may have an influence on the direction of the force and therefore on the orientations of the deformations of the foot under the effect of the force, in particular:
the angle formed by the conical or frustoconical geometry of the end 31,
the coefficient of friction between the end 31 and the shaping 231,
the orientation of the shaping 231 relative to the axis A1.

In order to maximum the axial component of the force, it is possible for example:
to minimize as far as possible the angle formed by the conical or frustoconical geometry of the end 31,
to minimize as far as possible the coefficient of friction between the end 31 and the shaping 231,
to orient the direction normal to the shaping 231 so that it is parallel to the axis A1.

As a preference, the elements are configured and/or arranged in such a way that the force is applied to the free end of the tongue or close to the free end of the tongue, which is to say some distance from the junction where the tongue meets the rest of the foot.

The thickness of the plate 21 may be standard, notably greater than or equal to 0.25 mm, or even greater than or equal to 0.35 mm, or even of the order of 0.4 mm.

The diameter d1 of the foot is greater than or equal to 0.7 mm, preferably greater than 0.95 mm. The diameter d1 is the diameter of a surface 221 of the foot, or of the smallest circle circumscribing the surface 221 of the foot (or circumscribing the outline of the cross section of the foot 22), the surface 221 allowing the dial to be guided or positioned in the housing 12 relative to the frame 11 or to the movement. The surface or the surfaces 221 notably allow the dial to be positioned with only a small amount of play.

The ratio of the diameter of the foot d1 (and more generally of the smallest circle circumscribing the surface 221) to the clearance j1 (d1/j1) is preferably greater than 25, or even greater than 50, or even still greater than 100.

The foot length 11 is preferably less than 2 times the foot diameter d1, or even less than 1.5 times the foot diameter d1. The foot length 11 is the length between the proximal end and the distal end of the foot.

The dimensions of the base 24 need to be sufficient to:
on the one hand, allow the dial to be positioned within a mount without the risk of damaging the geometry of the foot collaborating with the housing (as will be seen in greater detail later on), and
on the other hand, make the insetting of the dial foot more rigid.

To achieve this, the base diameter d2 is at least greater than the diameter d1 and preferably 1.5 times greater than the diameter d1 so that the base can be considered to be infinitely rigid in comparison with the foot of diameter d1, and more generally in comparison with the rest of the foot 22. Likewise, the base height h1 preferably equates to at least 0.25 times the total length 11 of the foot.

The notch height h is dimensioned so as to be able to receive the first portion 31 of the fixing element 30, in this instance the end 31 of the screw 30. Its depth p is chosen so that it does not prejudice the rigidity of the foot 21 too greatly. As a preference, the thickness e2 (the greatest distance between the end of the notch and the guide surface of diameter d1) of remaining material is greater than the radius r1 of the foot r1=d1/2, or even greater than ⅔ of the diameter d1 of the foot.

The zone 40 of lower rigidity here has enough thickness e1 to press optimally on the dial. This thickness is, for example, greater than 0.15 mm or of the order of 0.2 mm. As a preference, the thickness e1 is also a factor of 3 times smaller than the thickness e2, so that the foot can be considered to be infinitely rigid in comparison with the zone 40 of lower rigidity. With such geometries, the zone 40 of lower rigidity may have a cross section that has a second moment of area (or moment of inertia) about a given axis perpendicular to the axis A1 and also perpendicular to the direction in which the zone 40 of lower rigidity extends, that is markedly lower than the second moment of area (or moment of inertia) about an axis parallel to said given axis of a section of the foot at which the thickness e2 is measured.

Finally, the penetration of the first portion 31 of the fixing element 30 into the notch 23 is designed to cause localized deformation, more particularly localized bending and/or work-hardening, of the zone 40 of less than 0.2 mm or even of less than 0.15 mm, or even still of less than 0.1 mm. The deformation of the zone 40 of lower rigidity may be plastic and/or elastic deformation.

In this way, with the deformation of the zone 40 of lower rigidity, the dial plate deformation caused by the fixing element 30 may typically be defective flatness of less than 0.1 mm, or even less than 0.05 mm, or even still less than 0.015 mm.

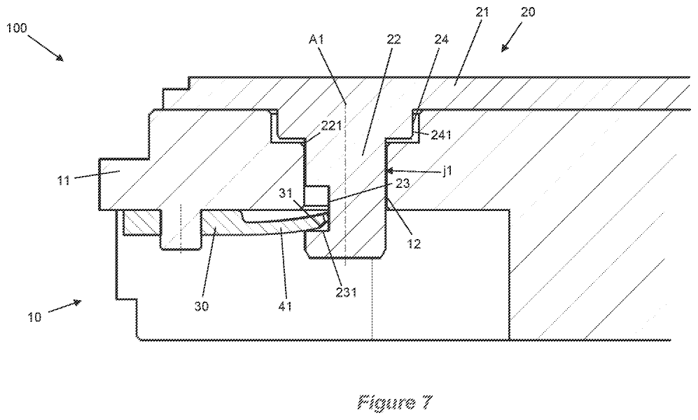

In a second embodiment set out in FIG. 7, which is an alternative to that described hereinabove, the dial could be made from a hard and/or brittle material. Therefore, the zone of lower rigidity 41 would be arranged within the fixing element 30 which:
would then be made from a material less hard and/or more flexible than the dial, or
would comprise a portion made from a material that is less hard and/or more flexible than the dial.

In other words, the dial could be made from a technical grade ceramic and the fixing element 30 could be a key or a blade made of steel having a zone of lower rigidity that would deform and become lodged pressing against the shaping 231, notably in the notch 23 of the dial foot 22 when the fixing device is in the locked first configuration E1. In such a case, the shaping against which the fixing element 30 presses could have a geometry and/or a material that is more rigid than the zone of lower rigidity arranged on the feet and described with reference to the embodiment depicted in FIGS. 1 to 6. Accordingly, it is the fixing element 30 that then comprises a zone 41 of lower rigidity configured or arranged in such a way as to deform elastically and/or plastically when a mechanical action is applied by the pressing zone 31 to the shaping 231 of a dial foot 22. The zone 41 of lower rigidity may have a portion in the form of a flexible blade intended to be connected to the frame 11 at one of its ends, the flexible blade being:
intended to extend perpendicularly to the axis A1 of the foot, and
liable to be mainly deformed as the mechanical action is applied to the shaping 231.

In a further alternative to that described hereinabove, the zone of lower rigidity could be arranged within the foot and within the fixing element 30 so that the deformation is distributed between the foot and the fixing element. In other words, the zone of lower rigidity could be distributed over two portions within the foot and within the fixing element 30, these two portions being intended to come into contact with one another.

Whatever the embodiment or variant, at least one portion of the zone of lower rigidity could be attached to a foot, notably to an end of a foot. By way of example, an attached elastic blade could constitute the zone of lower rigidity. Thus, it is possible for the foot not to be monobloc.

The dial depicted in this document is of round and planar shape. However, whatever the embodiment or variant, the dial may be of any shape. In particular, it may have a square, rectangular, elliptical, round or any exterior shape. Furthermore, the dial may notably be:
flat, or
domed and recessed, or
domed.

Whatever the embodiment or variant, the feet and/or the housings may have non-circular, for example substantially triangular, cross sections. Of course, all other shapes that allow statically determinate and/or precise positioning of the dial within the movement may be envisioned.

Moreover, whatever the embodiment or variant, the feet and/or the housings may also not be completely cylindrical but be at least partially frustoconical or have at their ends surfaces created by angling. Thus, when assembling the dial on the movement, it is possible to facilitate the engagement of the dial in the housings.

Whatever the embodiment or variant, the notch 23 may have a cross section other than a substantially rectangular cross section. It may, for example, be triangular and/or of rounded shape.

Whatever the embodiment or variant, the fixing element 30 may be a dial key or an eccentric or a blade, in the manner of those known from the aforementioned applications CH1775367A4 and CH610705B. The dial key or the eccentric or the blade described in these applications would still collaborate with the shaping 231 without shearing the foot, but by acting on the zone of lower rigidity. Of course, any other means allowing the dial to be locked by collaborating with the shaping is conceivable. For example, the dial key or the eccentric or the blade may comprise a zone of lower rigidity and deform axially when the fixing element is in the locked first configuration E1, so as to press the dial against the movement. The foot therefore experiences no deformation in this example, or else these deformations are very negligible.

Whatever the embodiment or variant, when the assembly 100 comprising the movement 10 with the dial 20 is fitted into a case middle, the dial 20 may press against this case middle or against a flange so as to be pressed against the movement, in addition to being held on the frame 11 by the fixing device. This makes the assembly of the dial on the movement more rigid still and ensures that it is held even more firmly in place.

Whatever the embodiment or variant, the dial may comprise one or more feet. In instances in which it comprises several feet, the dial may be held on the frame 11 as seen earlier at:
just one foot, or
just certain feet, or
all of the feet.

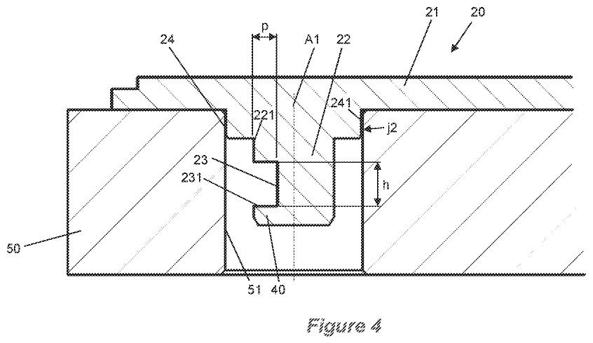

The invention may also relate to an assembly depicted in FIG. 4 and including:
a mount 50 comprising housings 51 to receive feet 22, and
a dial 20 as described hereinabove.

In such cases, the base or bases 24 described above are advantageously used to position the dial 20 more precisely in the housings 51 of the mount 50. This mount is advantageously used to allow the operations of machining, decorating or finishing of the dial to be performed. Thanks to such a mount, the surface 221 of the foot which surface is intended to collaborate with the housing 12 may advantageously be masked during these operations to prevent it from being damaged and from therefore impairing the positioning of the dial within the movement. As a preference, the base 24 is fitted closely into the housing 51 with a radial clearance j2 that is as small as the radial clearance j1 between the foot 22 and the housing 12, as illustrated in FIG. 4. The base 24 or the bases 24 comprise positioning surfaces 241 which are intended for positioning the dial, with the least possible amount of clearance, relative to the mount 50 in the housing or housings 51. The surface or surfaces 241 are preferably located at a proximal end of the feet.

As described previously in relation to the assembling of the dial 20 on the frame 11, a similar statically determinate assembly (with feet of different formats and/or housings of different formats) is also preferred for the positioning of the dial on the mount 50.

As a preference, the length or the height h1 of the base 24 is also advantageously chosen to ensure optimal guidance within a mount 50.

The solutions described hereinabove allow optimal positioning of a dial relative to a movement. Unlike the various known fixing devices, notably those employing dials with feet, these solutions offer a high level of precision in the assembly, making corrections of the position of the dial relative to the movement superfluous.

In addition, in the absence of a skirt, these solutions offer the freedom to use a dial that is not necessarily of a size comparable to that of the movement. Moreover, these solutions are particularly well suited to a timepiece, particularly to a movement, that is provided with several control members on its periphery, such as a chronograph or chime movement.

To sum up, and in other words, the solutions take the form of a dial comprising feet, the positionings of which are very precise. As a result, the assembly clearances or the fit between the feet and the movement may advantageously be reduced to a functional minimum.

Specifically, because of the reduced clearances afforded by the proposed solution, it is necessary for the fixing of the dial to maintain the geometric integrity of the feet within the movement during the various fitting and removal steps, because a lateral or radial deformation of a foot could cause the feet to jam in the movement and/or impair the positioning of the dial.

Advantageously, the proposed solution is able to overcome these problems while at the same time offering a fixing that allows the dial to be pressed against the movement without play. In order to achieve this, the dial feet are shaped in such a way that a means for fixing the dial can generate only mainly axial deformation in a defined zone, without any impact on the fitting-together of the feet and the movement, notably in a plane parallel to or coincident with that of the dial plate.

1. A dial for a timepiece, the dial comprising:
a dial plate, and
at least one dial foot extending along a foot axis,
the at least one foot comprising:
a shaping oriented toward the dial plate and adapted to receive a mechanical action that presses the plate against a clockwork movement, and
a first zone of lower rigidity configured or arranged to deform elastically and/or plastically, in a direction mainly parallel to the foot axis as the mechanical action is applied to the shaping,
wherein the first zone of lower rigidity is arranged and/or configured to have a portion provided with a lower material profile so as to constitute a portion of the dial that is able to be mainly deformed or experience most of the deformation as the mechanical action is applied to the shaping, and
wherein the first zone of lower rigidity forms a flexible blade extending substantially perpendicular to the axis of the foot and set into a rest of the foot at one of ends thereof.

2. The dial according to claim 1, wherein the first zone of lower rigidity is positioned at a distal end of the foot and has a first thickness between:
the shaping, and
the distal end of the foot,
the first thickness being at least two times smaller than a thickness of a smallest cross-section of the foot found between the shaping and the plate.

3. The dial according to claim 1, wherein the plate and the at least one foot are monobloc or formed as a single piece.

4. The dial according to claim 1, wherein the foot comprises positioning surfaces adapted for positioning the dial with a smallest amount of play relative to a mount and/or relative to a clockwork movement.

5. The dial according to claim 4, wherein one or some of the positioning surfaces or all of the positioning surfaces are located at a proximal end of the foot.

6. The dial according to claim 4, wherein the foot comprises a base on which at least one of the positioning surfaces is formed, the base having cross sections transverse to the foot, of which cross sectional areas are greater than cross sectional areas of other zones of the foot.

7. The dial according to claim 1, wherein the dial comprises several feet positioned relative to one another and/or relative to the dial plate with a positioning tolerance of less than 60 μm.

8. A fixing element intended to be mounted on a clockwork movement, the fixing element comprising:
a pressing zone adapted to press against a shaping of a dial foot, and
a second zone of lower rigidity configured or designed to deform elastically and/or plastically when a mechanical action is being applied by the pressing zone to the shaping of a dial foot.

9. The fixing element according to claim 8, wherein the second zone of lower rigidity is arranged and/or configured to exhibit a portion in the form of a flexible blade intended to be connected to a frame at one of its ends, the flexible blade being:
intended to extend substantially perpendicular to an axis of a foot, and
capable of being mainly deformed as the mechanical action is applied to the shaping.

10. An assembly comprising:
a clockwork movement comprising at least one housing adapted to receive a foot or a mount comprising at least one housing to receive a foot, and
a dial according to claim 1.

11. The assembly according to claim 10, wherein the foot comprises positioning surfaces adapted for positioning the dial with a smallest amount of play relative to a mount and/or relative to a clockwork movement and wherein
(i) a radial clearance between:
at least one of the positioning surfaces, and
one of the housings,
is less than 40 μm,
and/or
(ii) a ratio:
of a diameter of a smallest circle circumscribing the at least one of the positioning surfaces, to
the radial clearance between the at least one of the positioning surfaces and the housing,
is greater than 25.

12. The assembly according to claim 10, wherein at least one of the housings has an oblong cross section oriented in the direction of another of the housings.

13. A timepiece comprising a dial according to claim 1.

14. The dial according to claim 1, wherein the foot axis is perpendicular or substantially perpendicular to the dial plate.

15. The dial according to claim 1, wherein the shaping is adapted to receive a mechanical action that presses the plate against a frame of a clockwork movement.

16. The dial according to claim 4, wherein the positioning surfaces are adapted for positioning the dial with a smallest amount of play relative to a frame of a clockwork movement.

17. The dial according to claim 1, wherein the dial comprises several feet positioned relative to one another and/or relative to the dial plate with a positioning tolerance of less than 40 μm.

18. The dial according to claim 1, wherein the dial comprises several feet positioned relative to one another and/or relative to the dial plate with a positioning tolerance of less than 20 μm.

19. The fixing element according to claim 8, which is adapted to be mounted on a frame of a clockwork movement.

20. The fixing element according to claim 9, wherein the flexible blade is capable of being mainly deformed in bending as the mechanical action is applied to the shaping.
